(19) United States
(12) Patent Application Publication
(10) Pub. No.: US 2010/0139497 A1
(43) Pub. Date: Jun. 10, 2010

(54) FOOD HEATING DEVICE

(75) Inventors: TERRY TAE-IL CHUNG, BARTLETT, IL (US); LOREN VELTROP, CHICAGO, IL (US); BRIAN HEE-EUN LEE, WEST CHICAGO, IL (US); DONALD VAN ERDEN, WILDWOOD, IL (US); CHRISTOPHER B. LYONS, LAGRANGE PARK, IL (US)

Correspondence Address: Docket Clerk, 1000 JORIE BOULEVARD SUITE 144, OAK BROOK, IL, 60523, US

(73) Assignee: PRINCE CASTLE INC., CAROL STREAM, IL (US)

(21) Appl. No.: 12/329,413

(22) Filed: Dec. 5, 2008

(51) Int. Cl. A47J 37/08

(52) U.S. Cl. 99/386

(57) ABSTRACT

A food heating device (100) includes a first conveyor (107) having a first thermally-conductive belt (105) and a second conveyor (107) having a second thermally-conductive belt (105). A first platen (101) is disposed on a first side of the first thermally-conductive belt (105) and a second platen (103) disposed on a first side of the second thermally-conductive belt (105). The first conveyor (107) and the second conveyor (107) are arranged and spaced to transport a food product (201, 203, 205) between a second side of the first thermally-conductive belt (105) and a second side of the second thermally-conductive belt (105).

### FIELD OF THE INVENTION

This invention relates to apparatus utilized in food preparation. Such apparatus include, but not limited to, apparatus utilized in the heating of food products such as bread-type food products, including buns, rolls, croissants, bagels, muffins, and the like, as well as pasta, vegetables, cakes, pastries, and so forth.

### BACKGROUND OF THE INVENTION

Restaurants often heat bread-type food products, referred to hereinafter as bread products, ranging from bread slices to buns, rolls, croissants, bagels, and the like. Such heating may include warming, toasting or browning (also known as a Maillard reaction), and steaming.

At times, it may be desired to process different parts of a food product differently, although the food product is desired to be completed or assembled at the same time. For example, a club-type sandwich typically includes a bun with a top, a center, and a bottom. Such a sandwich often requires the center to be toasted on both sides, while the top and bottom need only be toasted on one side.

Accordingly, there is a need for a heating device that can heat multiple parts of a food product so that all components are heated in substantially the same amount of time.

### BRIEF DESCRIPTION OF THE DRAWINGS

FIG. 1 is a perspective view of a heating device having platens and thermally-conductive belts in accordance with the invention.

FIG. 2 and FIG. 3 are front views of a platen illustrating internal heating elements in accordance with the invention.

FIG. 4 is a top view of a pair of platens disposed within a pair of thermally-conductive belts in accordance with the invention.

FIG. 5 is a side view of a pair of platens disposed within a pair of thermally-conductive belts in accordance with the invention.

### DESCRIPTION OF A PREFERRED EMBODIMENT

The following describes an apparatus for and method of heating, also known as heat processing, food products, such as bread-type food products, including buns, rolls, croissants, bagels, muffins, flatbread, pitas, and the like, as well as pasta, vegetables, cakes, pastries, and so forth.

Platens are disclosed that heat one and/or both sides of a food product. Each platen advantageously comprises one or more heating elements. The heating elements are utilized to heat, including, for example, to heat process, warm, toast or brown (also known as a Maillard reaction), steam, grill, defrost, and/or thaw. The platens are typically planar and may be disposed horizontally, vertically, or a combination thereof. The platens shown in the drawings are not necessarily shown proportional to their actual size. The platens are ideally comprised of a material with good heat transfer properties, such as aluminum, steel, ceramic, and/or other thermally conductive materials, and advantageously have a smooth, non-stick surface. The length, width, and temperature of the platen(s) are selected to provide the desired heating when used in conjunction with one or more conveyors, whose speed may also be variable.

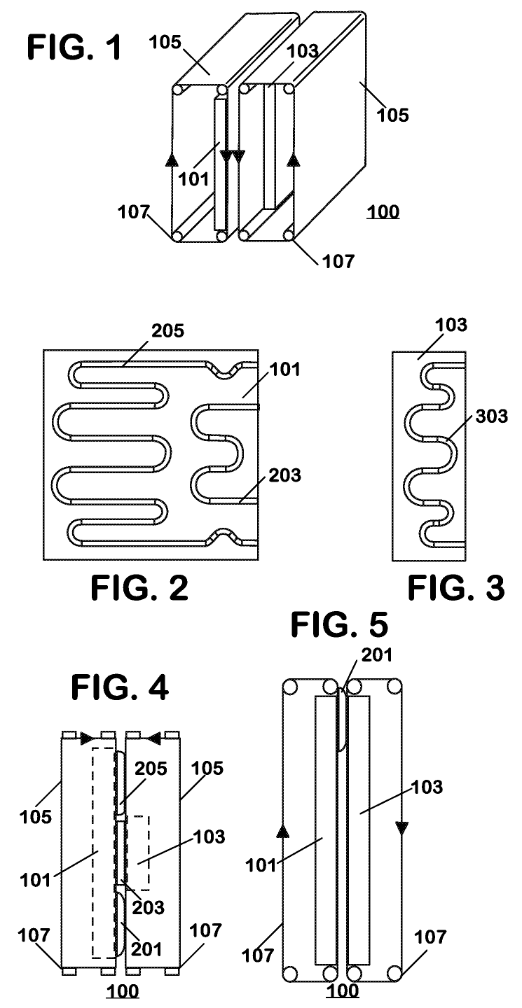

A perspective view of a heating device 100 having platens and thermally-conductive belts is shown in FIG. 1. The heating device 100 has a pair of conveyors 107 that have thermally-conductive belts 105. Belt Technologies, Inc. sells such belts made from stainless steel, as well as corresponding conveyors, for food processing. The thermally-conductive belts 105 may have a non-stick coating. The food product is static relative to the belts 105 of the conveyors 107, which is dynamic relative to the platen 101. As a result, the heat transfer rate is higher and food sticking is reduced. Brackets, stands, and electrical connections for the conveyors and platens (not shown) are known in the art. The rollers of the conveyors 107 may be closer together or further apart than shown in the drawings. The conveyors herein may be components of a single conveyor system, having a single shared conveyor belt among multiple conveyors, or each conveyor may be separate, where each conveyor has its own conveyor belt. The claims and claim limitations should be construed accordingly. Although the heating device 100 is shown in a vertical position, it may be horizontally disposed.

A first platen 101 is disposed next to or near the inside of a first thermally-conductive belt 105, and a second platen 103 is disposed next to or near the inner surface of a second thermally-conductive belt 105, such that the platens 101, 103 are in thermal contact with the thermally-conductive belts 105. The food products are heated as they are guided between the outer surfaces of the thermally-conductive belts 105.

A front view of platen 101 with internal heating elements is shown in FIG. 2 and a front view of platen 103 with internal heating elements is shown in FIG. 3. The platen 101 may include one or more heating elements 203, 205, and the platen 103 may include one or more heating elements 303. The platen can also have a non-stick surface. Many other arrangements of heating elements may be successfully utilized other than the example shown in the drawings, including, for example, one or more heating elements, different paths of the heating elements, and so forth.

In an alternate embodiment of a food heating device (not shown), one conveyor 107 depicted in FIG. 1 is disposed next to a single heated platen 101 depicted in FIG. 2. In such an embodiment, the stationary platen 101 heats a first side of a food product while the conveyor 107 having a belt 105, heated by a second platen 103, heats the opposite, second side of the same food product. Because the heated platens 101 and 103 in such an embodiment can be controlled individually and separately, it is possible to vary the heat provided to one side of a food product such that it is possible to selectably heat both sides of a food product or only a single side, simply by not heating one of the platens 101 and 103. Configuring or arranging multiple conveyors 107 side-by-side to face a fixed, heated platen 101, enables the different sides of the different parts of a multi-part of 3-part bread product to be heated in the same amount of time, simply by controlling the heat provided by the platens 101 and 103. A first conveyor 107 having a belt 105 heated by a platen 103 and disposed next to a fixed platen 101 can heat a first side of a center section 203 while the fixed platen 101 heats the second side of the center section 203. A second conveyor adjacent to the first conveyer and configured with or without a heated belt runs the top 201 and bottom 205 sections along the same heated platen 101.

The food product is shown in FIG. 4 and FIG. 5 in the example of a 3-part bun for a round club-type sandwich, including a top 201, a center 203, and a bottom 205, so named for the sake of reference, but not necessarily orientation. With this example, which will be utilized throughout the drawings, the center 203 is desired to be toasted on both sides, whereas the top 201 and 205 are toasted on one side.

In the top view shown of the heating device 100 shown in FIG. 4, all three parts of a 3-part bread product 201, 203, 205 are heated by the first platen 101. The second platen 103 is narrower than the first platen 101, thus only the center 203 is heated by the second platen 103, as shown in FIG. 4, because the center 203 travels between the two platens 101, 103. The top 201 and bottom 205 are guided outside the space between the first platen 101 and the second platen 103 and thus are not heated by the second platen 103. A side view of the heating device 100 is shown in FIG. 5. The top 201, center 203, and bottom 205 advantageously arrive at the end of the heating device 100 at substantially the same time, while all desired parts of the bun 201, 203, 205 are heated as desired. Optionally, one or more parts of the belt may be comprised of a wire mesh or non-thermally-conductive material, instead of a thermally-conductive material, for example, in parts of the conveyor belt where the food product need only be heated on one side.

The heating device as set forth herein has many advantages, including heating all sides of the food products as required in the same, or nearly the same, time period. The counter space necessary for the heating device is minimized. The conveyors may be optimally used to reduce the size of the heating device. Use of thermally-conductive belts result in a simple heating device that is easy to use. By use of a conveyor belt that is in static contact with the food product, the heat transfer rate is higher and food sticking is reduced.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A food heating device comprising:
a first conveyor having a first thermally-conductive belt;
a first platen disposed on a first side of the first thermally-conductive belt;
a second conveyor having a second thermally-conductive belt;
a second platen disposed on a first side of the second thermally-conductive belt;
wherein the first conveyor and the second conveyor are arranged and spaced to transport a food product between a second side of the first thermally-conductive belt and a second side of the second thermally-conductive belt.

2. The food heating device of claim 1, wherein the second platen is narrower than the first platen, and the food product is heated on both sides while being transported between the first platen and the second platen.

3. The food heating device of claim 1, wherein the platen comprises a heating element.

4. The food heating device of claim 1, wherein the food product comprises a bread product, pasta, a vegetable, a cake, or a pastry.

5. The food heating device of claim 1, wherein the first platen and the second platen are planar and are disposed horizontally.

6. The food heating device of claim 1, wherein the first platen and the second platen are planar and are disposed vertically.

7. The food heating device of claim 1, wherein the first platen and the second platen are arranged and constructed to toast the food product.

8. The food heating device of claim 1, wherein the food product is static relative to at least one of the first thermally-conductive belt and the second thermally-conductive belt.

9. A method comprising the steps of:
applying heat to a first thermally-conductive belt in thermal contact with a first platen;
applying heat to a second thermally-conductive belt in thermal contact with a second platen;
guiding a food product between the first thermally-conductive belt and the second thermally-conductive belt.

10. The method of claim 9, wherein the second platen is narrower than the first platen, and further comprising the step of heating the food product on both sides while guiding the food product between the first platen and the second platen.

11. The method of claim 9, wherein the second platen is narrower than the first platen, and further comprising the step of heating the food product on one side while guided outside the space between the first platen and the second platen.

12. The method of claim 9, wherein the second platen is narrower than the first platen, and wherein two sides of a first food product are heated while guided between the first platen and the second platen in substantially the same time as one side of a second food product is heated while guided outside the space between the first platen and the second platen.

13. The method of claim 9, wherein the step of guiding takes place in a horizontal direction.

14. The method of claim 9, wherein the step of guiding takes place in a vertical direction.

15. The method of claim 9, further comprising the step of toasting the food product by at least one of the first platen and the second platen.

16. The method of claim 9, wherein the first thermally-conductive belt is driven by a first conveyor, and the second thermally-conductive belt is driven by a second conveyor.

17. The method of claim 9, further comprising retaining the food product as static relative to at least one of the first thermally-conductive belt and the second thermally-conductive belt.

18. A food heating device comprising:
a first conveyor having a first thermally-conductive belt;
a first platen disposed on a first side of the first thermally-conductive belt;
wherein the first conveyor and the second conveyor are arranged and spaced to transport a food product between a second side of the first thermally-conductive belt and a second side of the second thermally-conductive belt.

19. The food heating device of claim 18, wherein the first platen and the first conveyor are disposed vertically.

20. The food heating device of claim 18, wherein the first platen and the first conveyor are arranged and constructed to toast first and second sides of the food product.

21. The food heating device of claim 18 wherein the first platen is provided a non-stick surface.

22. The food heating device of claim 21, wherein the food product is static relative to the first thermally-conductive belt.
